(19) United States
(12) Patent Application Publication
(10) Pub. No.: US 2020/0147833 A1
(43) Pub. Date: May 14, 2020

(54) MOULDED PART, METHOD FOR PRODUCING A MOULDED PART, METHOD FOR ADHESIVELY BONDING A MOULDED PART TO AN ARTICLE AND USE OF A WOVEN OR NONWOVEN FABRIC

(71) Applicant: ACO Severin Ahlmann GmbH & Co. Kommanditgesellschaft, Budelsdorf (DE)

(72) Inventor: Karsten Volkmann, Sudergellersen (DE)

(21) Appl. No.: 16/603,987

(22) PCT Filed: Apr. 25, 2018
(86) PCT No.: PCT/EP2018/060538

§ 371 Date: Oct. 9, 2019

(30) Foreign Application Priority Data
Apr. 26, 2017 (DE) 10 2017 108 984.5

(51) Int. Cl. B28B 7/00; B29C 33/68

(52) U.S. Cl. CPC B28B 7/0064; B29C 67/243; B29C 33/68

(57) ABSTRACT

The invention relates to a moulded part of a composite material comprising a main body (10) of polymer concrete or of reaction resin, which has at least one adhesion bonding surface (11) for adhesively bonding to an article, wherein the adhesive bonding surface (11) is detachably connected to a laminate layer (12) texturing the adhesive bonding surface (11).

The invention relates to a molded part, to a method for producing a molded part, to a method for adhesively bonding a molded part to an article and to the use of a woven or nonwoven fabric.

In civil engineering, components of polymer concrete are used, for example, in the form of drainage channels or settling tanks which frequently consist of adhesively bonded components. Before the adhesive bonding, the bonding surfaces are prepared by a surface treatment. In practice, the adhesive surfaces are roughened with a grinding disk and then cleaned. This method is expensive, and, if applied incorrectly, it leads to defective adhesive bonding connections.

U.S. Pat. No. 7,021,919 B2 describes a method for producing mold blocks of concrete having at least one textured surface. The textured surface should exclusively determine the optical appearance of the concrete block. Here, the surfaces should be simulated as realistically as possible, and identical texturing patterns should be avoided. For this purpose, a mold is used, which has a continuous circumferential fabric tape, on one side. During removal from the mold, the circumferential fabric tape also turns and applies a corresponding texturing to the block surface. The fabric tape remains in the mold. This method is not provided for the surface treatment for adhesive bonding connections. In addition, the texturing applied by the known method has the disadvantage that the texturing is unprotected after the removal of the block from the mold, so that, in case of incorrect use, the texture can be damaged.

The underlying aim of the invention is to disclose a molded part which has an adhesive bonding surface for adhesively bonding to an article, wherein the adhesive bonding surface is prepared for the preparation of the adhesive bonding step. Other underlying aims of the invention are to provide a method for producing such a molded part, a method for adhesively bonding a molded part to an article, and the use of a woven or nonwoven fabric.

According to the invention, this aim is achieved, with a view to the molded part, by the subject matter of claim 1, alternatively by the subject matter according to claim 7, with a view to the production method by the subject matter of claim 8 (polymer concrete composite material) or by the subject matter of claim 11 (reaction resin composite material). With a view to the method for adhesive bonding, the aim is achieved by the subject matter of claim 15, and with a view to the use of a nonwoven fabric, the aim is achieved by the subject matter from 16.

The invention is based on the idea of providing a molded part of a composite material, which has a main body of polymer concrete or of reaction resin. The main body has at least one adhesive bonding surface for adhesive bonding to an article. The adhesive bonding surface is detachably connected to a laminate layer texturing the adhesive bonding surface. As laminate layer, a nonwoven fabric, for example, a fleece, or a woven material can be used. It is important that the texture of the laminate layer is transferred to the adhesive bonding surface, in order to increase the adhesive bonding surface.

According to the invention, reaction resins are understood to mean any resins consisting of at least two components, namely a resin and a curing agent. In particular, reaction resins can in addition contain fillers, accelerators and other additives, namely flow improvers, shrinkage inhibitors, adhesion promoters and/or crosslinking agents as reaction resin components.

In principle, a low-viscosity highly reactive reaction residue, which is suitable without problem for almost all the conventional polymer concrete processing methods, is used. Here, during the reaction resin adjustments, the selection of the starting material property is unimportant, such as, for example, light-stabilized, reactivity- and viscosity-optimized, thixotropized, as well as preaccelerated and environmentally friendly.

Since the molded part forms a composite material comprising the main body and the laminate layer, the molded part should be handled together with the laminate layer as a unit, i.e., as a connected component.

Advantageously, the polymer concrete or the reaction resin, on the surface of the molded part, has a reactive (wet) closed surface, which, at least on the surface of the molded part, has a high viscosity, so that the textured laminate layer can be inserted. In this manner, it is achieved that the textured laminate layer is enclosed preferably completely by the polymer concrete or by the reaction resin. This has the effect, that after the subsequent tearing off of the textured laminate layer, a reactive (chemical) surface and/or frictional connection surface (physical anchoring in the surface) is/are available on the molded part according to the invention. Surprisingly, it has been found that, even after months, the (chemical) reactivity of the polymer concrete or of the reaction resin can be restored after the removal of the laminate layer. The physical anchoring in the surface of the molded part via the increase of the surface of the molded part by means of the laminate layer is always possible, provided the textured laminate layer is not damaged or partially dissolved.

The invention has the advantage that the texture of the laminate layer is transferred to the adhesive bonding surface. By pulling or tearing the laminate layer from the adhesive bonding surface, the texture of the adhesive bonding surface is exposed. The molded part is thereby subjected to a surface treatment for adhesively bonding to another article. In concrete terms, the adhesive bonding surface is roughened. The pulling off of the laminate layer occurs more rapidly and less problematically than in the case of the roughening of the adhesive bonding surface as carried out to date using a grinding disk. In addition, the entire adhesive bonding surface is reliably textured. This depended particularly strongly on the working method and the carefulness of the processor. In addition, it has been shown that, in the case of an adhesive bonding surface according to the invention which has been subjected to a preliminary treatment, the adhesive forces are higher than the adhesive forces of an adhesive bonding surface produced according to the prior art.

In addition, it is advantageous that, after the tearing off of the laminate layer, the surface is clean, dry, even and dust-free, and not contaminated with dust or other environmental properties, but instead suitable directly for adhesive bonding (frictional connection adhesive bond) with additional materials. This remains the case even after longer time periods, for example, after years.

Preferred embodiments of the invention are the subject matter of the dependent claims. Preferably, the laminate layer comprises a woven fabric, in particular a plastic woven fabric. It is particularly preferable to use a polyamide woven fabric (nylon). Woven fabrics are simple, flexible, and sufficiently rough to apply a satisfactory texturing to the adhesive bonding surface. In addition, the woven fabric is sufficiently firm to be detached before the adhesive bonding from the adhesive bonding surface.

In a preferred embodiment, the woven fabric has a plain weave or a twill weave. The plain weave or twill weave is characterized by a particularly tight crossing of the warp and weft threads. In addition, the two sides of the plain weave or of the twill weave are identical in terms of bonding. Thus, in the processing of the laminate layer or of the woven fabric, it does not matter which side is applied to the adhesive bonding layer.

In another preferred embodiment, the laminate layer comprises a woven fabric, in particular fleece, in particular a plastic fleece or a metal fleece.

The method according to the invention for producing a molded part consisting of a polymer concrete composite material is based on the fact that a mold corresponding to a main body of the molded part is filled with a molding compound of polymer concrete with formation of at least one adhesive bonding surface and cured in the mold. Before the curing of the molding compound, the adhesive bonding surface is detachably connected to a laminate layer texturing the adhesive bonding surface. The laminate layer remains on the adhesive bonding surface during the removal of the molded part from the mold.

The method according to the invention has the advantage that the laminate layer can adapt to the contour of the adhesive bonding surface. The laminate layer protects the adhesive bonding surface or its textured surface and can remain on the adhesive bonding surface until shortly before the application of the adhesive.

Preferably, the laminate layer is inserted into the mold before filling and wetted with the molding compound of polymer concrete.

After the filling, in particular after the removal from the mold, the laminate layer can be removed. The time point of the removal is arbitrary. Thus, the laminate layer can function as a protective layer during the storage of the molded part.

The method according to the invention for producing a molded part consisting of a reaction resin composite material is based on the fact that a mold corresponding to a main body of the molded part is filled with a paste of reaction resin with formation of at least one adhesive bonding surface. The paste cures in the mold. Before the curing of the paste, the adhesive bonding surface is detachably connected to a laminate layer texturing the adhesive bonding surface. Here too, the laminate layer adapts to the contour of the adhesive bonding surface and protects it. The texture of the laminate layer is transferred to the adhesive bonding surface.

Preferably, the laminate layer is applied to the moist paste and connected to it. In contrast to the production method for a molded part of polymer concrete composite material, the laminate layer is connected at the end of the production process to the main body of the molded part, and, in particular, as long as the paste from which the molded part is produced is still moist.

In a particularly preferred embodiment, the laminate layer remains on the adhesive bonding surface during the removal of the molded part from the mold. However, this is not absolutely necessary, since the molded part can be further processed immediately after the curing and remain in the mold for that purpose. For storage, however, the molded part can be removed from the mold, wherein the laminate layer remains on the adhesive bonding surface.

In a particularly preferred embodiment, the laminate layer remains on the adhesive bonding surface after the removal of the molded part from the mold, until the molded part adhesively bonds to the article and protects it.

According to the invention, a method is proposed for the adhesive bonding of a molded part according to the invention, which consists of a polymer concrete composite material, to an article, comprising the following steps:
removing the laminate layer from the adhesive bonding surface of the molded part of polymer concrete composite material,
applying an adhesive to the exposed adhesive bonding surface, and
connecting the adhesive bonding surface to the article.

Alternatively, a method is proposed for adhesively bonding a molded part according to the invention, which consists of a reaction resin composite material, comprising the following steps:
fixing the molded part of polymer concrete or reaction resin composite material in a mold and removing the laminate layer from the adhesive bonding surface of the molded part,
filling the mold with a molding compound of polymer concrete, wherein the adhesive bonding surface is covered with the molding compound,
curing the molding compound
removing the molded parts of reaction resin and/or polymer concrete, which are connected to one another.

In the two methods for the adhesive bonding (frictional connection) of molded parts, one of the two components is produced from polymer concrete. On the one hand, the molded part itself is produced from a polymer concrete composite material. On the other hand, the counter-piece which is connected to the molded part of reaction resin composite material is made of polymer concrete. Therefore, what is important in both cases is that the adhesive bonding surface is sufficiently prepared, i.e., sufficiently textured.

According to the invention, the use of a woven fabric, in particular of a plastic woven fabric for the surface preparation of a molded part of polymer concrete or of a reaction resin is claimed, which can be connected to an article by adhesive bonding, wherein the woven fabric is detachably connected to an adhesive bonding surface of the molded part.

Below, the invention is explained further with additional details by means of embodiment examples in reference to the appended diagrammatic figures.

In said figures,

FIG. 1 shows an untreated molded part

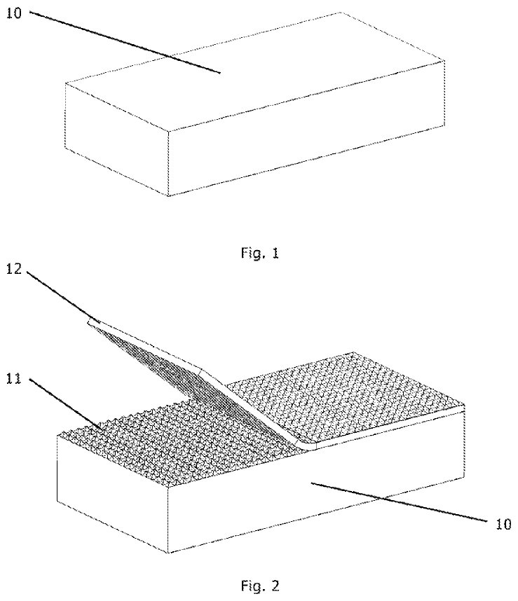

FIG. 2 shows a molded part according to an embodiment example according to the invention, in which the laminate layer has been partially removed and the textured adhesive bonding surface is shown in sections;

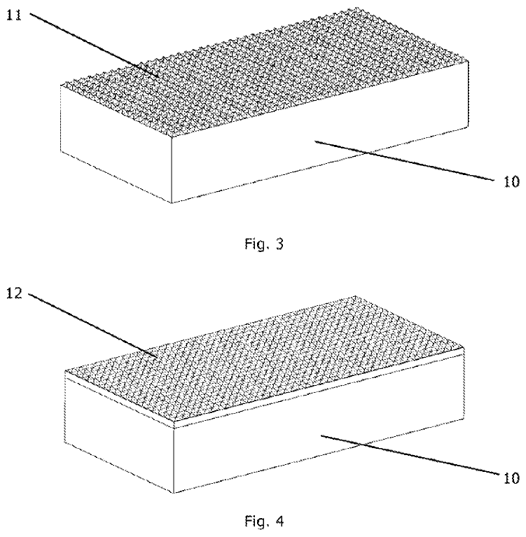

FIG. 3 shows the molded part according to FIG. 2, in which the laminate layer has been completely removed; and

FIG. 4 shows the molded part according to FIG. 2, in which the laminate layer completely covers the adhesive bonding surface.

The molded part according to an example according to the invention, which can be produced by the method explained above, forms a component of an end-use composite article or product, in which individual components, in concrete terms the molded part and a counter-piece, are adhesively bonded to one another. The end product is in general a component which is used in civil engineering, wherein one of the adhesively bonded components of the product is produced from a polymer concrete.

As examples, polymer concrete channels or settling tanks made of polymer concrete are mentioned, which are adhesively bonded to add-on parts, in particular add-on molded parts. The add-on parts can be, for example, a pipe connection plate for a settling tank made of polymer concrete. The pipe connection plate is designed as a polymer concrete molded part.

The molded part can also be produced from a reaction resin, in particular a filled reaction resin. For example, such a molded part is an add-on part of a drainage channel made of polymer concrete.

In both examples, what is important is that the adhesive surfaces of the individual components of the end product adhere securely to one another. For this purpose, the adhesive bonding surface or bonding surface of the molded part is subjected to a surface treatment. The surface treatment occurs by means of a texturing laminate layer, in particular a woven or nonwoven fabric which is detachably connected to the molded part during the manufacture thereof. By means of the detachable connection of the laminate layer to the molded part, in concrete terms to the adhesive bonding surface of the molded part, it is achieved that the texture of the laminate layer is transferred to the adhesive bonding surface. Thereby, a sufficient roughness of the adhesive bonding surface is generated, which ensures a good adhesive bonding.

In the context of the invention, the molded part is thus disclosed together with the laminate layer as a composite material and claimed, wherein one material partner is the laminate layer and the other material partner is the material of the main body of the molded part, that is to say the polymer concrete or reaction resin. The composite material can be handled and stored as a unit.

In addition, the molded part itself, that is to say, without the laminate layer, is disclosed and claimed, wherein the adhesive bonding surface on the main body of the molded part has a substantially regular texture corresponding to a plain weave. The molded part is produced by the production method according to the invention, in which the texture of the woven fabric is transferred with the plain weave to the adhesive bonding surface. This results in the texture of the adhesive bonding surface corresponding to the texture of a plain weave.

In the plain weave, the warp threads and the weft threads are intermeshed alternately with one another. The plain weave or twill weave itself is known per se and therefore not described further.

It is also possible to use a nonwoven fabric, for example, a fleece, as laminate layer.

Below, the production method for a molded part of polymer concrete is described in greater detail and, in particular, using an example of a pipe connection plate for a settling tank made of polymer concrete.

Here, the laminate layer 12 is cut in the form of a polyamide woven fabric (nylon) with plain weave and inserted into a mold. Subsequently, the laminate layer 12 is fixed with a mold weight. The mold weight at the same time forms the future pipe connection opening. Then, the molding compound of polymer concrete is filled into the mold. In the process, the laminate layer 12 is wetted over the entire surface with the molding compound. During the wetting, the texture of the layer 12, in concrete terms the texture of the polyamide woven fabric (nylon) is imprinted into the molded composition. The bottom surface of the mold, to which the laminate layer 12 is applied, determines the form of the adhesive bonding surface after the curing of the molding compound which can be curved, for example. The laminate layer is adapted in accordance with the form of the bottom or of the adhesive bonding surface.

After the curing, the molded part forms a main body 10 with an adhesion connection surface 11. On the adhesion connection surface 11, the laminate layer 12 is arranged and detachably connected to it, as shown in FIGS. 2 and 4.

The molded part with the laminate layer 12 and the main body 10 of polymer concrete forms a composite material which, in this form, that is to say with the laminate layer 12 and the main body 10, can be handled, for example, stored or sold. The laminate layer 12 here protects the texture of the adhesive bonding surface 11.

Shortly before the processing, i.e., before the adhesive bonding of the molded part, the laminate layer 12 is pulled off the adhesive bonding surface 11 (FIG. 2). The adhesive bonding surface 11 thus exposed is then coated with adhesive. The molded part which has thus been pretreated and provided with adhesive can then be connected to an article, for example, the outer wall of a settling tank made of polymer concrete, in a manner which in itself is known.

The same principle of texture transfer from the laminate layer 12 to the adhesive bonding surface 11 is the basis of an additional production method according to an example of the invention, wherein, instead of polymer concrete, a filled reaction resin is used for the molded part.

Here, a paste of reaction resin is filled into a mold, in order to produce a preform therefrom, for example, in the shape of a horseshoe for a drainage channel. In contrast to the above-described method, the adhesive bonding surface 11 is arranged at the top on the mold and thus freely accessible during the process.

In the next step, a laminate layer 12 is placed on the freely accessible adhesive bonding surface 11 and pressed on, so that said laminate layer is fixed on the still moist paste. After the curing, the molded part forms a main body 10, on the adhesive bonding surface 11 of which the laminate layer 12 is detachably connected. The cured main body 10 is removed from the mold.

The preform so formed is ready for further processing, for example, for storage. The molded part or the preform is a composite body consisting of a main body 10 of reaction resin and a laminate layer 12 which is detachably connected to the adhesive bonding surface 11 of the main body 10.

For further processing, the preform or the molded part is fixed. The laminate layer 12 is removed, in particular by tearing off or peeling off, so that the adhesive connection layer 11 is exposed. The surface structure of the adhesive bonding surface 11 is constructed evenly and finished for the polymer concrete connection. For this purpose, the mold which fixes the main body 10 of the molded part is inserted into a box mold. The mold is filled with fresh molding compound of polymer concrete, wherein the exposed adhesive bonding surface 11 is wetted with the molding compound. After the curing of the molding compound, the component is molded and forms a frictional adhesive connection. The product thus consists of 2 components, namely the preform with the main body 10 of reaction resin and the closure piece of a drainage channel made of polymer concrete on which the preform is attached. The smooth surface of the preform of reaction resin is used, for example, as a contact surface for a gasket.

The above-described preliminary treatment enables a new manufacturing technology for protecting and securing permanently reproducible adhesive bonding connections on all known polymer concrete surfaces. Here, it is not important whether the molded part pretreated with the laminate layer is to be further processed by adhesive bonding within the shortest time period or within a long time period.

An example of a molded part is represented in FIGS. 2 to 4. The molded part can be formed from polymer concrete or reaction resin. FIG. 4 shows the composite component comprising the main body 10 and the laminate layer 12. In FIG. 2, the laminate layer 12 is partially removed, so that a section of the textured adhesive bonding surface 11 is exposed. The texturing is understood to be diagrammatic and can be seen easily in comparison to the untreated surface of the main body 10 according to FIG. 1. In FIG. 3, the main body 10 is shown with textured adhesive bonding surface 11 without laminate layer 12, which has been removed completely.

Tests have shown that the adhesive compound due to the polymer concrete surface textured with the woven fabric or with the nonwoven fabric is stronger than the adhesive compound due to the ground polymer concrete surface. In concrete terms, the average bending resistance is approximately 2 N/mm² higher in a molded part whose surface has been textured with the laminate layer.

### LIST OF REFERENCE NUMERALS

10 Main body
11 Adhesive bonding surface
12 Laminate layer

1. A molded part of a composite material comprising a main body (10) of polymer concrete or of reaction resin, the main body (10) comprising at least one adhesive bonding surface (11) for adhesively bonding to an article, wherein the adhesive bonding surface (11) is detachably connected to a laminate layer (12) texturing the adhesive bonding surface (11).

2. The molded part according to claim 1, wherein the laminate layer (11) comprises a woven fabric.

3. The molded part according to claim 2, wherein the woven fabric is a plastic woven fabric having a plain weave.

4. The molded part according to claim 1, wherein the laminate layer (11) comprises a nonwoven fleece fabric.

5. The molded part according to claim 1, wherein the reaction resin comprises a resin and a curing agent.

6. The molded part according to claim 5, wherein the reaction resin further comprises fillers, accelerators, flow improvers, shrinkage inhibitors, adhesion promoters or wetting agents.

7. A molded part with a main body (10) of polymer concrete or of reaction resin, the main body (10) comprising at least one adhesive bonding surface (11) for adhesively bonding to an article, wherein the adhesive bonding surface (11) comprises a surface structure with a texture of a plain weave.

8. A method for producing a molded part of a polymer concrete composite material, in which a mold (13) corresponding to a main body (10) of the molded part is filled with molding compound (14) of polymer concrete with formation of at least one adhesive bonding surface (11) and cured in the mold, wherein, before the curing of the molding compound (14), the adhesive bonding surface (11) is detachably connected to a laminate layer (12) texturing the adhesive bonding surface (11), the laminate layer (12), during the removal of the molded part from the mold, remains on the adhesive bonding surface (11).

9. The method according to claim 8, wherein the laminate layer (12) is placed in the mold before filling the mold with the molding compound (14) of polymer concrete.

10. The method according to claim 9, wherein after the removal of the molded part from the mold, the laminate layer (12) is removed.

11. A method for producing a molded part of a reaction resin composite material, in which a mold (15) corresponding to a main body (10) of the molded part is filled with a paste (16) of reaction resin with formation of at least one adhesive bonding surface (11) and cured in the mold, wherein, before the curing of the paste (16), the adhesive bonding surface (11) is detachably connected to a laminate layer (12) texturing the adhesive bonding surface (11).

12. The method according to claim 11, wherein the laminate layer (12) is applied to the paste (16) and connected to the paste (16).

13. The method according to claim 11, wherein during the removal of the molded part from the mold, the laminate layer (12) remains on the adhesive bonding surface (11).

14. The method according to claim 13, wherein after the removal of the molded part from the mold, the laminate layer (12) remains on the adhesive bonding surface (11) until the adhesive bonding of the molded part to an article.

15. A method for adhesively bonding a molded part according to an article, comprising the following steps:
removing the laminate layer (12) from the adhesive bonding surface (11) of the molded part of polymer concrete composite material or reaction resin to form an exposed adhesive bonding surface (11),
applying an adhesive (17) to the exposed adhesive bonding surface (11), and
connecting the adhesive bonding surface (11) to the article, or
fixing the molded part of polymer concrete or reaction resin composite material in a mold (15) and removing the laminate layer (12) from the adhesive bonding surface (11) of the molded part,
filling the mold (15) with a molding compound (14) of polymer concrete or reaction resin, wherein the adhesive bonding surface (11) is covered with the molding compound (14),
curing the molding compound (14), and
removing the molded part of reaction resin and/or polymer concrete.

16. A use of a woven or nonwoven fabric for the surface preparation of a molded part of polymer concrete or of reaction resin, the molded part being connected to an article by adhesive bonding, wherein the woven or nonwoven fabric is detachably connected to an adhesive bonding surface (11) of the molded part.
